(19) United States
(12) Patent Application Publication
(10) Pub. No.: US 2012/0045538 A1
(43) Pub. Date: Feb. 23, 2012

(54) Nutrient team

(76) Inventor: Ari Blumofe, Lincolnwood, IL (US)

(21) Appl. No.: 12/806,795

(22) Filed: Aug. 23, 2010

(51) Int. Cl. A23L 1/30

(52) U.S. Cl. 426/2

(57) ABSTRACT

The invention provides a method of improving the ingestion of nutrients. The method involves ingesting nutrients in two different forms. At least one form may be a solid and one form may be a liquid form. At least one of the solid and liquid forms contains a nutrient team that increases the absorption of nutrients. At least one of the solid and liquid forms contains a bully that is separated from nutrients in the other form and thereby prevents the bully from impairing nutrient absorption. By properly teaming up and separating nutrients, greater absorption of nutrients can be achieved with lower dosages, following the physiological rules regarding vitamin pairs and teams; necessary for nutrient absorption or usage. This is especially the case where lowering the dosage of calcium allows many other nutrients to be absorbed at much higher levels. The solid form can be tasty and satiating encouraging proper diet and weight loss, without any stigma for using “special” products, for special diets; or contain condition specific (and/or age or other specificity based criteria) based special nutrients and nutrition. The liquid can be tasty and voluminous enough to help satisfy one's fluid intake requirements.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention is directed to nutritional supplements. In particular, this invention is directed to nutritional supplements for improving health by insuring correct intake of nutrients needed for disease prevention and protection against nutritional losses and deficiencies due to such factors as lifestyle patterns and common inadequate dietary patterns. In both the first and third world there exists a crisis in nutrition. The crisis in the third world is due to a lack of necessary foodstuffs. The crisis in the first world is due to the lack of correct utilization of food resources. This crisis is compounded by the fact that the particular nutritional needs for various people differs by such factors as age, sex, lifestyle, and so forth.

Previous attempts to resolve this crisis, such as those described in U.S. Pat. Nos. 6,953,588, 6,881,419 and 6,488,956 involved pills formulated for a particular target population. These pill-based supplements however have by and large failed for a number of reasons. First, pill based regimens are not compatible with how people view the eating process. Consumers expect feeding to be a sensory experience with tastes, smells, and sense of becoming satiated. Because pills don't provide these sensations, compliance with pill based dietary supplement plans is less than 50%.

Furthermore pills just don't work very well. The interacting chemistry of the digestive tract with solid swallowed pills results in at best 10-35% of all the nutrients in a solid pill are absorbed by the dieter. Moreover, pills can irritate the stomach of many individuals; both in the general population, as well as those with certain disease or surgically induced condition sensitive to pills. The remaining nutrients are passed on as waste. As a result in the United States, we are faced with a situation where there is simultaneous malnutrition and obesity, and these twin crises are having catastrophic results. In light of the fact that the WHO estimates that there are about 1.2 billion overweight people in the world and an equal number of malnourished people in the world there definitely exists a need for a better manner of supplementing nutrients in people's diets.

The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. §1.56(a) exists.

### BRIEF SUMMARY OF THE INVENTION

At least one embodiment of the invention is directed towards a method of improving the ingestion of nutrients into an organism's GI tract. The method comprises the steps of: ingesting a first composition and a second composition. The first composition is predominantly liquid. The liquid is stored in a container labeled such that it is readily recognizable as containing nutrients but not labeled such that it is readily recognizable that the nutrients are selected to treat a specific medical condition. The second composition comprises a solid and has no more than 80 calories. The first and second compositions not ingested closer than one hour to each other. At least one of the first and the second compositions contains a first nutrient and a second nutrient. The simultaneous ingestion of the first and second nutrients enhances the absorption of the first nutrient. The second composition contains at least one additional nutrient which is substantially absent from the first composition and if ingested simultaneous to the first composition the additional nutrient would inhibit the absorption of a nutrient within the first composition.

The second composition may comprise calcium and effectively contains no iron and the first composition contains iron and effectively contains no calcium. The composition may contain a variety of nutrients appropriate for general healthy nutrition and the second composition may contain a specific assortment of nutrients targeted towards a specific illness or medical condition. The specific medical condition may be gastric bypass and first composition may contain vitamin B12 and other recommended nutrients, and the second composition contains additional nutrients for this condition. Gastric Bypass can cause both malnutrition and mal-absorption in a person. The first and second compositions when combined may contain no more than 3% of the US RDA of calcium. The solid may be an edible snack comprising one item selected from the list consisting of granola, chocolate, nuts, soy, tofu, amino acids, protein, calcium, other nutrients and any combination thereof.

The first and second compositions, if ingested simultaneously may result in less than 50% of at least one of two nutrients being absorbed and when the method is performed more than 50% the two nutrients are absorbed by the organism's GI tract. The first and second nutrients may have dosages no greater than 200% of the US RDA except for Vitamin D. The solid edible snack may comprise a hollow lumen, the hollow lumen at least partially filled with at least one liquid filling, the liquid filling comprising a third nutrient, the third nutrient being a nutrient which is readily absorbed by the body when drunk in liquid form whose absorption is interfered with by at least one nutrient in the first composition. The first composition may be ingested in a location where its identification as treating a particular condition would produce a stigma that would deter a user from ingesting it. The solid may be massive enough and chewy enough to stimulate the sensation of satiation after being consumed.

The first composition may comprise one item selected from the group consisting of: water, Emulgold, Gum Acacia, Citric Acid, Maltodextrin, Natural Flavors, Acesulfame-K, Sucralose, Red 40, Blue 1, Beta-carotene, ascorbic acid, folic acid, cholecalciferol, d-Alpha Tocopheryl acetate, phytonadione, thiamine, mono-nitrate, ferrous lactate, riboflavin, niacinamide, pyridoxine hydrochloride, cyanocobalamin, biotin, d-calcium Pantothenate, selenomethionine, copper gluconate, manganese ascorbate, potassium iodate, molybdenum citrate, vanadium citrate, chromium picolinate, calcium lactate, manganese lactate, dimagnesoim phosphate, zinc gluconate, insoitol, chromium bitartrate, and any combination thereof.

The medical condition may be gastric band patients, finicky eaters, children, cancer patients, Chrones patients, people with other mal-nutritional environments or mal-absorptive conditions or vegetarians, and any combination thereof. The solid edible snack may be in the shape of a turtle. The second composition may comprise no more than 500 mg of calcium, omega 3, phosphorous in a 2:1 Calcium to Phosphorous ratio, and Amino Acids but not full proteins, other nutrients, or less nutrients, other forms of vitamins, whether solid or liquid. The second composition may comprise an additional nutrient which is not adversely affected by the nutrient in the first composition, but which are wanted for nutritional purposes.

### DETAILED DESCRIPTION OF THE INVENTION

For purposes of this application the definition of these terms is as follows:

“Bully” means one or more nutrients whose simultaneous presence with another nutrient in more than a trace amount impairs the body's ability to absorb or utilize the first nutrient.

“Dispersed” means a material which is distributed throughout a liquid medium in a substantially even manner, including but not limited to solutions, dispersions, emulsions, azeotropes, mixtures, and the like.

“Essentially contains” means contains in an amount large enough to have a detectable effect on the absorption or effectiveness of some nutrient.

“Liquid form” means a composition of matter that is effectively liquid, it includes solutions, liquids containing fine non-dissolved dispersed matter, and any combination thereof.

“Nutrient” means a composition of matter that an organism ingests to metabolically sustain itself and/or to physically grow, including but not limited to vitamins, minerals, amino acids, proteins, fats, and carbohydrates.

“Team” means two or more nutrients whose mutual presence results in at least one of the nutrients being more readily absorbed by a GI tract and/or being more effective in the body (utilized) than if the other of the two nutrients were absent.

In the event that the above definitions or a description stated elsewhere in this application is inconsistent with a meaning (explicit or implicit) which is commonly used, in a dictionary, or stated in a source incorporated by reference into this application, the application and the claim terms in particular are understood to be construed according to the definition or description in this application, and not according to the common definition, dictionary definition, or the definition that was incorporated by reference. In light of the above, in the event that a term can only be understood if it is construed by a dictionary, if the term is defined by the Kirk-Othmer Encyclopedia of Chemical Technology, 5th Edition, (2005), (Published by Wiley, John & Sons, Inc.) this definition shall control how the term is to be defined in the claims.

At least one embodiment of the invention is a method of providing a nutritional supplement to a person in a manner, which efficiently disseminates nutrients to the patient. The method involves the steps of providing at least two compositions of matter, one in liquid form (this form is superior, but solid is also possible) and often one being a solid (but can be a liquid or solid with a liquid core, or any other form). The liquid form may be stored in a container labeled such that it is readily recognizable as containing nutrients but not labeled such that it is readily recognizable that the nutrients are selected to treat a specific medical condition. The second composition may comprise a solid and has no more than 80 calories. The first and second compositions are recommended to be ingested no closer than one hour to each other.

In at least one embodiment at least one of the first and the second compositions contains a nutrient team which comprises at least one first nutrient and a second nutrient. The simultaneous ingestion of the first and second nutrients enhances the absorption of the first nutrient. In at least one embodiment the second composition contains at least one nutrient which if ingested simultaneous to the first composition would inhibit the absorption of a nutrient within the first composition.

In at least one embodiment the nutrient team comprises more than one nutrient whose absorption is enhanced by at least one other team member.

By placing the first composition in a container labeled such that it is readily recognizable as containing nutrients but not labeled such that it is readily recognizable that the nutrients are selected to treat a specific medical condition, a user is more likely to comply with a proper nutrition regimen. The neutrality of the label eliminates any stigma associated with a vitamin drink associated with a particular condition or ailment (especially with obesity, but also applicable to all conditions). Moreover by appearing to be part of a more general health plan it encourages positive peer pressure in the user to stick with their particular regimen. By simply assuring that the first composition is taken regularly, the second composition is also more likely to be taken as it is easier to stick with a regimen that they are already complying with.

The first composition has two or more ingredients that work well together which promotes and force absorption and or use by the body of those nutrients. Without these team members, supplementation of the rest of the group is limited or stopped. Useful or needed nutrients that impair the absorption of team nutrients are ingested separately in the second composition. The second composition can be a solid or a liquid or a solid with a liquid core. In at least one embodiment the first and second compositions together contains all of the RDA of nutrients necessary for basic nutrition of the general population, the first composition containing all of those nutrients that do not impair absorption of other nutrients and the second composition containing those that do impair absorption of their fellows.

In at least one embodiment the first composition contains a nutrient cocktail designed for general nutrition of the overall population and the second composition contains additional ingredients suitable for specific medical conditions or nutritional regimens. The second product can come in versions that are tailored to multiple conditions. It can also contain the separated nutrients intentionally added to the second product, as described above, as well as these condition specific nutrients.

In at least one embodiment the second composition contains no more than 500 mg of calcium (while it can have more, it would be wasteful, as the body cannot absorb more than this amount at any one time), omega 3, phosphorous in a 2:1 Calcium to Phosphorous ratio, and Amino Acids but not full proteins (which have added calories and are not more helpful). Other ingredients are possible as are the removal of some of these nutrients; for example, Amino Acids may not be correct to give as they have some calories. Another scenario may be certain conditions may require the limitation of a nutrient in the first or second product as it adversely affects the condition, and so forth.

In at least one embodiment the first product is in liquid form in order to promote ingestion closer to full and complete ingestion and absorption through the upper GI. Unlike pills that can have an absorption of 0-35% typically into the body. Yet, the second composition can come in any form as well—solid or solid with a liquid core, a liquid only and so forth.

The first and or the second compositions may be nutritionally targeted for specific ages, genders, ethnicity, environments, or other factors which are different from those relevant to the general population as a whole. For example, compositions tailor made for people over 50 would have less iron and more calcium than one for the general population.

In at least one embodiment the first composition has the iron and therefore little or zero calcium in it, because calcium is a bully that hinders iron and other nutrients from being absorbed.

In at least one embodiment the first composition is contained in one or more bottles. Each bottle is ingested as part of a regiment in which a user drinks 1 to 3 or more bottles a day. In at least one embodiment the bottle's ingestion are separated in time by 0-24 hours. In at least one embodiment any bottle in a day subsequent to a first bottle has less than the first bottle or no iron at all. In at least one embodiment the subsequent bottle contains one or more bullies relative to the first bottle's ingredients. In at least one embodiment a subsequent bottle has more calcium than the first bottle of a given day.

In at least one embodiment the method provides for the delivery of a condition specific nutrient regimen that avoids stigma associated with that condition. In at least one embodiment the regiment is delivered in an environment where stigma is a serious problem and could deter compliance, such as homes, schools, hospitals and work places, etc. In at least one embodiment the second condition targeting composition is a small innocuous edible snack that can be stored in a pocket and ingested discretely without providing an opportunity for onlookers to notice which condition it is for. In at least one embodiment, the snacks for various different conditions are shaped, colored, flavored, wrapped, and/or sized such that unless closely watched they appear the same.

In at least one embodiment between both compositions at least one nutrient is in a dosage of between 25% and 400% (where this upper amount is not meant to be a limitation or a highest amount, precluding higher amounts when it is appropriate to give higher amounts) of the full RDA of that nutrient. In at least one embodiment, no nutrient exceeds the RDA when such an excess leads to toxicity of another nutrient or depletion from the body of another nutrient. (For example excess ingestion of Vitamin B depletes the body of various B vitamins).

In at least one embodiment at least one of the vitamin teams and/or the bullies are those described in the paper A Harvard Medical School Special Health Report Vitamins and Minerals What You Need to Know, Meir J Stampfer et al, Harvard Health Publications (2008). In at least one embodiment the compositions substantially lack sodium and potassium, both of which are salts and may not be appropriate for many individuals. In at least one embodiment the regimen contains either Vitamin K or Vitamin E but not both. This is because Vitamin E is a vitamin that enables the blood to thin out and Vitamin K is a vitamin that enables the blood to clot thus impairing the effectiveness of each other. In at least one embodiment the regimen does not contain Vitamin K, as particular individuals are susceptible to blood clots and Vitamin K promotes blood clotting.

In at least one embodiment a regimen is designed to promote bone growth and comprises magnesium and calcium. Magnesium and calcium are both involved in the building of bone in the body. Calcium forms the outside, and magnesium is involved in the bone marrow. However because calcium interferes with the absorption of magnesium the two are best not ingested at the same time. The regimen involves the calcium being in one of the two compositions and the magnesium being in the other of the two.

In at least one embodiment the calcium is a bully for and is ingested in a different composition than ingested iron, zinc, magnesium, but is teamed up with vitamin D, whether vitamin D is in the same product or the partner product. In at least one embodiment selenium is in a composition in a team with vitamin C, Vitamin A, or vitamin E, and any combination thereof.

In at least one embodiment the liquid portion of the regimen is at least 12 ounces so it can help satisfy the minimum requirement for a person's fluid intake and contains no more than trace amounts of calcium. In at least one embodiment the solid forms contain amino acids but not full proteins. In at least one embodiment the solid forms contain calcium but no more than 500 mg in each because the body cannot absorb more than that. The drink and solid snacks contain at least one nutrient which cooperatively enhances the absorption of another nutrient in that solid snack or drink.

In at least one embodiment the method is used to supplement gastric bypass patients which have their stomach's bypassed. Such patients have difficulty absorbing Vitamin B12 and typically only absorb 1% of what they ingest through passive diffusion. Bypassed stomachs lack the activation and release of Intrinsic Factor, necessary for absorption in the ileum of the Vitamin B12. By utilizing liquid vitamin B12, absorption may be achieved beyond this passive 1% level, as it is absorbed through the upper GI.

Some nutrients are more suitable in liquid form as they are better absorbed. Other nutrients however are more suitable in solid form as they degrade when in prolonged contact with liquid or if in gastric juices without a solid shell. In at least one embodiment the first composition contains at least one nutrient which is better absorbed in liquid form and the second composition contains at least one nutrient which degrades if in prolonged contact with liquids or if within gastric juices without a solid shell.

Prior art nutritional supplements do not follow the most efficient pairings of various nutrients and nutrient pairs and teams. This is regrettable because often if one nutrient is provided but another is absent, the one nutrient will not be properly absorbed. Similarly, if certain nutrients are provided in the presence of other nutrients, those certain nutrients competitively react with the other nutrients and thereby prevent their absorption into the body. For example, if iron and calcium are simultaneously ingested, calcium will block the intake of iron. However the body cannot absorb more than 500 mg of calcium at a time so the presence of any calcium in a supplement virtually guarantees that the overwhelming majority of the iron will go to waste. Similarly, high levels of any B vitamin negates the absorption or depletes the body's stores of all other B vitamins; and vitamin A blocks the absorption of vitamin C unless in a specific ratio. In at least one embodiment the composition containing calcium contains no more than 10% of the RDA for calcium. The efficient way to address this situation is to approach nutritional supplement ingestion not as a single pill to be swallowed at once, but to be part of a series of fluid drinks and solid foods consumed over the course of the day. Even if the nutritional system was two liquids or two solids or any other form, the body has certain physiological rules that must be followed for correct and useful nutritional supplementation.

In at least one embodiment the solid contains between a 1:1 and a 3:1 molar ratio of phosphorous to calcium. In at least one embodiment the solid is chewable. In at least one embodiment the solid at least partially dissolves on contact with saliva.

In at least one embodiment the liquid-solid pair contains the proper dosages specifically targeted towards gastric band patients, finicky eaters, children, cancer patients, Chrones patients, and vegetarians. In at least one embodiment the liquid-solid pair team contains the proper dosages specifically targeted towards specific nutritional deficiencies.

In at least one embodiment, the number of drinks in the nutrition regimen is suited to the particular metabolism of the person. Children below the age of 8 receive one drink per day, people between 9 and 49 receive two drinks a day, and adults 50 and above receive one drink per day.

In at least one embodiment the nutrient dosages in a daily solid-drink regimen is no greater than the daily dosages prescribed in the PDR or the RDA or by a physician, and so forth. In at least one embodiment the compositions are low in or totally lack sugar, sodium, cholesterol and fats, gluten, allergens and other particular ingredients. In at least one embodiment one or more or all vitamins are only delivered in water soluble (not fat soluble) forms. The water soluble forms can be in a liquid form composition, or within a liquid form filling of a solid form composition.

In at least one embodiment the solid has a hollow lumen. In at least one embodiment the hollow lumen is at least partially filled with a nutrient bearing liquid form. This allows for the delivery of nutrients that themselves must (or are preferred to be) be in liquid form; but which may be preferred to be ingested substantially simultaneously with a solid nutrient that would otherwise not be present in a drink, for reasons including but not limited to absorption or satiety. The liquid filling also facilitates the ingestion of particular ingredients that have key specific ingredients needed for rapid stock absorption along with other nutrients in the solid portion that do not require rapid stock absorption.

In at least one embodiment the liquid filling contains one selected from the list consisting of calcium, phosphate, omega 3, and any combination thereof. The combination of the liquid filling along with a solid edible solid portion also connects the ingestion of particular nutrients with the enjoyable sensation of eating which greatly increases the probability of the user complying with the nutritional regimen. In at least one embodiment, the liquid filling is at least in part a hydrophobic/organic liquid, which allows for the dispersion of non-water soluble nutrients in a form that can be rapidly absorbed. In at least one embodiment the liquid core contains concentrated nutrients that require water to be drunk with the solid to properly dilute the nutrients and maximize their absorption.

The combination of the liquid drinks with edible solid snacks results in a nutritional regimen that is both effective and efficient. In prior art pills and liquids, the nutrients often cancel each other out or are not absorbed, so the manufacturer overdoses these unabsorbed nutrients. These overdoses are wasteful, still relatively ineffective, and in some cases are actually unhealthy. In at least one embodiment, the solid-drink pair contains no more than 200% of the RDA of any given nutrient.

In at least one embodiment the solid form comprises granola, candy, chocolate, a sweet tasting material, and any combination thereof. In at least one embodiment the solid is in the shape of a turtle.

In at least one embodiment the liquid drink and/or the solid comprises one item selected from the list consisting of: water, Emulgold (by Kerry Dairy Ingredients, Inc. Kerry Flavors, Kerry Ireland) Gum Acacia, Citric Acid, Maltodextrin, Natural Flavors, Acesulfame-K, Sucralose, Red 40, Blue 1, Beta-carotene, ascorbic acid, folic acid, cholecalciferol, d-Alpha Tocopheryl acetate, phytonadione, thiamine, mono-nitrate, ferrous lactate, riboflavin, niacinamide, pyridoxine hydrochloride, cyanocobalamin, biotin, d-calcium Pantothenate, selenomethionine, copper gluconate, manganese ascorbate, potassium iodate, molybdenum citrate, vanadium citrate, chromium picolinate, calcium lactate, manganese lactate, dimagnesoim phosphate, zinc gluconate, insoitol, chromium bitartrate, and any combination thereof. In at least one embodiment the liquid form needs to be shaken before ingestion to properly disperse at least some of the nutrients within the liquid form. These forms are not meant to be limitations, but are examples of highly bioavailable forms of these vitamins.

In at least one embodiment the dosages of at least one of the following nutrients are provided in the drinks or in the solids in the following amounts:

| | Per 8 fl oz servings | | Per 24 fl oz serving | |
|---|---|---|---|---|
| Carbohydrate | 2 | gm | 7 | gm |
| Dietary Fiber | 2 | gm | 5 | gm |
| Vanadium (Vanadium Citrate) | 8 | μg | 25 | μg |
| Inositol | 2 | mg | 5 | mg |
| Choline (Choline Bitartrate) | 167 | mg | 500 | mg |

| | % RDA DV per | % RDA DV per |
|---|---|---|
| | 8 fl oz serving | 24 fl oz serving |
| Vitamin A (Beta Carotene) | 33 | 100 |
| Vitamin C (Ascorbic Acid) | 67 | 200 |
| Folic Acid | 67 | 200 |
| Vitamin D3 (Cholecalcferol) | 83 | 250 |
| Vitamin E | | |
| (d, alpha, Tocopheryl Acetate) | 83 | 250 |
| Vitamin K1 (Phytonadione) | 33 | 100 |
| Thiamin (thiamin mononitrate) | 33 | 100 |
| Iron (ferrous lactate) | 33 | 100 |
| Riboflavin | 33 | 100 |
| Niacin (Niacinamide) | 33 | 100 |
| Pyroxidine | 33 | 100 |
| (Pyroxidine Hydrochloride) | | |
| Vitamin B-12 | 67 | 200 |
| (Cyanocobalamin) | | |
| Biotin | 67 | 200 |
| Patothenic Acid | 33 | 100 |
| (d-Calcium Pantothenate) | | |
| Selenium (selenomethionine) | 33 | 100 |
| Copper (Copper gluconate) | 33 | 100 |
| Manganese | 33 | 100 |
| (Manganese Ascorbate) | | |
| Iodine (potassium iodate) | 33 | 100 |
| Molybdenum | 33 | 100 |
| (molybdenum citrate) | | |
| Chromium | 33 | 100 |
| (chromium picolinate) | | |
| Calcium (Calcium lactate) | 33 | 100 |
| Magnesium | | |
| (Magnesium and | 33 | 100 |
| Dimagnesium phosphate) | | |
| Zinc (zinc gluconate) | 33 | 100 |
| Phosphorous | 33 | 100 |
| (dimagnesium phosphate) | | |

In at least one embodiment the nutrient teams and bullies are appropriately combined and separated according to the following table:

| A | B Complex | D | E | Calcium | Phosphorus | Zinc |
|---|---|---|---|---|---|---|
| D | A | C | Choline | Calcium | Phosphorus | |
| E | B Complex | Inostol | Choline | Manganese | | |
| C | Calcium | Magnsium | | | | |
| Folate | B Complex | C | | | | |
| Niacin | B1 | B2 | Choline | | | |
| B1 | B Complex | Folate | Niacin | Calcium | E | |
| B2 | B6 | C | Niacin | | | |
| B6 | B1 | B2 | Pantothenate | Calcium | Magnesium | |
| B12 | B6 | C | Folate | Choline | Inostol | |
| Copper & Zinc | Should be together to prevent copper from Depleting Zinc | | | | | |
| Calcium | A | C | D | Iron | Magnesium | Phosphorus |
| Iron | B12 | Folate | Choline | Calcium | C | |
| Magnesium | B6 | C | D | Calcium | Phosphorus | |
| Zinc | A | Calcium | Phosphorus | | | |

| | |
|---|---|
| Magnesium | Needed for Calcium & Vitamin C Absorption |

This table is an example of the multi-faceted and multi-partnered synergistic physiological interactions of nutrients; which work together in the absorption, utilization and control of other nutrients and of physiological processes in the body. The nutrient on the left column, works best with the other nutrients on that line with it—or even more than that, without them, it does not work at all. In at least one embodiment the nutrient team or teams or the avoided bullies are those listed in the book Earl Mindell's Vitamin Bible for the 21st Century, by Earl Mindell and Hester Mundis, Warner Books (1999).

If a team member is absent or is in incorrect ratios to its team member, the body does not function correctly. Foods often have correct team members and ratios. Most supplements do not.

In at least one embodiment the regimen comprises a substantially liquid composition combined with a substantially solid composition. The two can be ingested at substantially the same time and at different times. The liquid is a formulation suitable for general nutrition and has a significant iron and therefore low or no calcium in it. The partnering solid can be in at least two forms. In one form the partnering solid is suitable for nutrition of the general population and contains significant amounts of calcium and omega 3 and other general population nutrients. In another form the partnering solid is targeted for patients having a particular illness (or illnesses) and therefore the solid comprises calcium, phosphorus, amino acids, omega 3, and/or other condition specific nutrients.

In at least one embodiment the regimen is targeted for people who are 50 or more years old. The regimen comprises a first substantially liquid composition combined with another that is either substantially solid or second substantially liquid composition. The two can be ingested substantially at the same time or at different times. The first liquid is a formulation suitable for people over 50 and has age appropriate recommended amounts of iron in it. The partnering solid (or liquid) can be in at least two forms. In one form the partnering solid is suitable for nutrition of the general population. In another form the partnering solid has the general population nutrients or condition specific nutrients, but also has everything from the first liquid except nutrients that are required to be reduced, such as iron. This scenario is appropriate, among others, for people wanting two “first” liquid compositions, but are age restricted from this level of iron (or other nutrients), and need to compensate for the missing nutrients in the partnering second liquid or solid composition.

In the alternative, the first liquid will have the standard nutrients, minus iron. Then the partnering liquid or solid will have the general population nutrients or condition specific nutrients. This scenario can also apply to people that are medically restricted form ingesting iron in the first place, at any age.

While this invention may be embodied in many different forms, there are shown in the drawings and described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments described herein and incorporated herein.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

This completes the description of the preferred and alternate embodiments of the invention. Those skilled in the art may recognize other equivalents to the specific embodiment described herein which equivalents are intended to be encompassed by the claims attached hereto.

1. A method of improving the ingestion of nutrients into an organism's GI tract, the method comprising the steps of:
ingesting a first composition and a second composition, wherein:
the first composition is predominantly liquid, the liquid stored in a container labeled such that it is readily recognizable as containing nutrients but not labeled such that it is readily recognizable that the nutrients are selected to treat a specific medical condition,
the second composition comprises a solid and has no more than 80 calories,
the first and second compositions not ingested closer than one hour to each other,
at least one of the first and the second compositions contains a first nutrient and a second nutrient, the simultaneous ingestion of the first and second nutrients enhances the absorption of the first nutrient,
the second composition contains at least one additional nutrient which is substantially absent from the first composition and if ingested simultaneous to the first composition the additional nutrient would inhibit the absorption of a nutrient within the first composition.

2. The method of claim 1 wherein the second composition comprises calcium and effectively contains no iron and the first composition contains iron and effectively contains no calcium.

3. The method of claim 1 wherein the first composition contains a variety of nutrients appropriate for general healthy nutrition and the second composition contains a specific assortment of nutrients targeted towards a specific illness or medical condition.

4. The method of claim 1 wherein the specific medical condition is gastric bypass and first composition contains vitamin B12 and other recommended nutrients, and the second composition contains additional nutrients for this condition. Gastric Bypass can cause both malnutrition and mal-absorption in a person.

5. The method of claim 1 wherein the first and second compositions combined contain no more than 3% of the US RDA of calcium.

6. The method of claim 1 wherein the solid is an edible snack comprising one item selected from the list consisting of granola, chocolate, nuts, soy, tofu, amino acids, protein, calcium, other nutrients and any combination thereof.

7. The method of claim 1 wherein the first and second compositions, if ingested simultaneously would result in less than 50% of at least one of two nutrients, wherein more than 50% the two nutrients are absorbed by the organism's GI tract.

8. The method of claim 1 wherein the first and second nutrients are in dosages no greater than 200% of the US RDA except for Vitamin D.

9. The method of claim 1 wherein the edible snack comprises a hollow lumen, the hollow lumen at least partially filled with at least one liquid filling, the liquid filling comprising a third nutrient, the third nutrient being a nutrient which is readily absorbed by the body when drunk in liquid form whose absorption is interfered with by at least one nutrient in the first composition.

10. The method of claim 1 wherein the first composition is ingested in a location where its identification as treating a particular condition would produce a stigma that would deter a user from ingesting it.

11. The method of claim 1 wherein the solid is massive enough and chewy enough to stimulate the sensation of satiation after being consumed.

12. The method of claim 1 wherein the first composition comprises one item selected from the group consisting of: water, Emulgold, Gum Acacia, Citric Acid, Maltodextrin, Natural Flavors, Acesulfame-K, Sucralose, Red 40, Blue 1, Beta-carotene, ascorbic acid, folic acid, cholecalciferol, d-Alpha Tocopheryl acetate, phytonadione, thiamine, mono-nitrate, ferrous lactate, riboflavin, niacinamide, pyridoxine hydrochloride, cyanocobalamin, biotin, d-calcium Pantothenate, selenomethionine, copper gluconate, manganese ascorbate, potassium iodate, molybdenum citrate, vanadium citrate, chromium picolinate, calcium lactate, manganese lactate, dimagnesoim phosphate, zinc gluconate, insoitol, chromium bitartrate, and any combination thereof.

13. The method of claim 3 wherein the medical condition is gastric band patients, finicky eaters, children, cancer patients, Chrones patients, people with other mal-nutritional environments or mal-absorptive conditions or vegetarians, and any combination thereof.

14. The method of claim 11 wherein the edible snack is in the shape of a turtle.

15. The method of claim 1 wherein the second composition comprises no more than 500 mg of calcium, omega 3, phosphorous in a 2:1 Calcium to Phosphorous ratio, and Amino Acids but not full proteins, other nutrients, or less nutrients, other forms of vitamins, whether solid or liquid.

16. The method of claim 1 wherein the second composition comprises an additional nutrient which is not adversely affected by the nutrients in the first composition, but which are wanted for nutritional purposes.
